(19) United States
(12) Patent Application Publication
(10) Pub. No.: US 2005/0235083 A1
(43) Pub. Date: Oct. 20, 2005

(54) Computer system

(76) Inventors: Yuji Tsushima, Hachioji (JP); Toshiomi Moriki, Kunitachi (JP)

Correspondence Address: Stanley P. Fisher;Reed Smith LLP, Suite 1400, 3110 Fairview Park Drive, Falls Church, VA, 22042-4503, US

(21) Appl. No.: 11/105,478

(22) Filed: Apr. 14, 2005

(30) Foreign Application Priority Data
Apr. 19, 2004 (JP) 2004-122453

(51) Int. Cl. G06F 13/00

(52) U.S. Cl. 710/104

(57) ABSTRACT

To provide a computer including: a hypervisor for operating an OS on each of a plurality of LPAR's into which a physical computer is divided, and controlling resource allocation of the physical computer to each LPAR; a PCI bus provided with a plurality of slots; a south bridge (6) for controlling the PCI bus; a BMC (7) for individually sending first reset signals to the slots in response to a request from the hypervisor, and a bus initialization unit for sensing a second reset signal to the entire PCI bus. The bus initialization unit sends the second reset signal at least at the time of booting the computer, and initialization is carried out for each slot based on one of the first and second reset signals. Thus, it is possible to prevent complexity of on-board circuitry while enabling dynamic changing of an I/O device of a virtual computer.

### CLAIM OF PRIORITY

The present application claims priority from Japanese application P2004-122453 filed on Apr. 19, 2004, the content of which is hereby incorporated by reference into this application.

### BACKGROUND

This invention relates to a virtual computer system, and more particularly to a technology of dynamically changing allocation of I/O devices to a plurality of logical partitions.

An increase in the number of servers has been accompanied by an increase in operational complexity, causing a problem of operational costs. Accordingly, server integration that integrates a plurality of servers into one has attracted attention as a technology of reducing operational costs. As a technology of realizing server integration, there has been known a virtual computer that logically divides one computer at an optional ratio. A plurality of physical computers are divided into a plurality of logical partitions (LPAR's) by firmware (or middleware) such as a hypervisor, computer resources (CPU, main memory, and I/O) are allocated to each LPAR, and an OS is operated on each LPAR. The CPU is used in a time-division manner, and thus flexible server integration can be realized.

In such a virtual computer, resources allocated to LPAR's can be dynamically changed, necessitating dynamic changing of allocation of I/O devices, and allocation to a new LPAR after resetting is required.

In the case of using a PCI bus as an I/O device, a PCI slot must be allocated to each LPAR. In the case of making a dynamic change, it is necessary to initialize only a PCI slot that has been allocated (or will be allocated) to a relevant LPAR. However, since it has only a reset signal for initializing all the slots, the PCI bus cannot be used for dynamic resource allocation of the LPAR.

On the other hand, as a technology of initializing PCI slots independently of one another, there has been known a technology of providing a PCI bus bridge between a PCI bus and the slot to cause a PCI device to correspond to a hot plug, and disposing an additional control circuit on the slot side (e.g., JP 09-146875).

### SUMMARY

However, in the case of the PCI slot as described above, resetting can be executed in accordance with the hot plug of the PCI device, while there is no means for resetting from the firmware such as the hypervisor, and the technology cannot be applied to logical division.

In the conventional example, the bus bridge and the additional control circuit are necessary for each slot, and thus on-board circuitry becomes complex, causing a problem of a cost increase.

This invention has been made in view of the aforementioned problems, and it is therefore an object of this invention to prevent complexity of on-board circuitry while enabling dynamic changing of an I/O device by a virtual computer.

According to a first embodiment of this invention, there is provided a computer including: firmware that divides a physical computer into a plurality of logical partitions, operates an OS on each logical partition, and allocates resources of the physical computer to the logical partitions; an I/O bus including a plurality of slots; an I/O control unit that controls the I/O bus; and a slot initialization unit that individually sends a first reset signal to each of the slots, the I/O control unit including a bus initialization unit that sends a second reset signal to the entire I/O bus, the bus initialization unit sending the second reset signal at least at a time of booting the computer, the slots each being initialized based on one of the first reset signal and the second reset signal. When there is a slot allocation releasing request after the slot allocation request is made from the firmware, the first reset signal is sent to the slot, and the slot is initialized.

Thus, according to this invention, since the initialization of the I/O bus that performs logical division can be dynamically carried out on a slot basis in response to a command from a hypervisor, it is not necessary to limit a type of OS or slot device operated on the hypervisor. This invention can be adapted to a broad range of hardware configurations, and especially it is possible to realize a virtual computer on a personal computer (PC) in addition to a PC server.

Furthermore, it is only necessary to add a new reset signal to the I/O bus of the existing computer for each slot. Thus, it is possible to dynamically change the I/O device of the virtual computer while preventing complexity of on-board circuitry of the computer.

### BRIEF DESCRIPTION OF THE DRAWINGS

FIG. 1 is a system diagram showing a configuration of a physical computer according to a first embodiment of this invention.

FIG. 2 is a system diagram showing a software configuration of a virtual computer operated on the physical computer.

FIG. 3 is a system diagram showing a BMC and an I/O bus in detail.

FIG. 4 is a system diagram showing a BMC and an I/O bus according to a first modified example in detail.

FIG. 5 is a system diagram showing a BMC and an I/O bus according to a second embodiment in detail.

FIG. 6 is a system diagram showing a configuration of a physical computer according to a third modified example.

### DETAILED DESCRIPTION OF THE PREFERRED EMBODIMENTS

Hereinafter, an embodiment of this invention will be described with reference to the accompanying drawings.

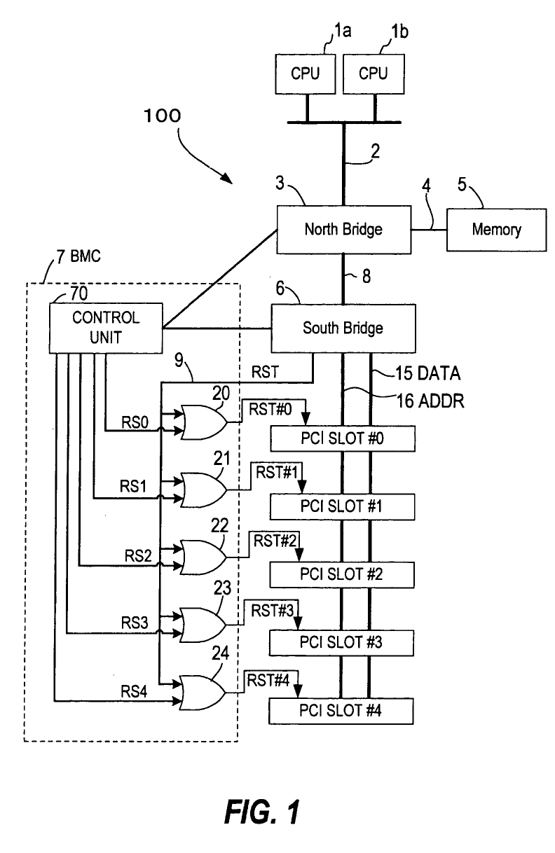

FIG. 1 shows a configuration of a physical computer 100 for operating a virtual computer system of according to a first embodiment of this invention. CPU's 1a and 1b are connected through a front side bus 2 to a north bridge 3.

The north bridge 3 is connected through a memory bus 4 to a memory 5, and connected through a bus 8 to a south bridge 6. A PCI bus, a legacy device (not shown), and a disk interface (not shown) are connected to the south bridge 6, which can be accessed from the CPU's 1a and 1b.

The PCI bus (I/O bus) shares a data bus 15, an address bus 16, and a reset signal 9 at PCI slots #0 to #4. A power source (not shown) is shared by the PCI slots #0 to #4. It should be noted that the reset signal 9 is turned ON at least at the time of booting the physical computer 100 to initialize all the PCI slots #0 to #4.

Further, the north bridge 3 and the south bridge 6 are connected to a baseboard management controller (BMC) 7 for monitoring on-board hardware, and the hardware connected to each bridge is monitored. The BMC 7 includes a control unit 70, and monitors a voltage, a temperature, an error, or the like of the on-board hardware and notifies an OS or the like of the information. The BMC 7 manages the PCI bus (described later).

As described above, one reset signal 9 is supplied from the south bridge 6. The reset signal 9 is used for resetting (initializing) all the PCI slots #0 to #4 at the time of staring the system.

The BMC 7 includes the control unit 70 and OR gates 20 to 24 for individually resetting the PCI slots #0 to #4.

That is, when one of a reset signal RS0 from the control unit 70 and the reset signal 9 from the south bridge 6 becomes ON, the OR gate 20 turns ON a reset signal RST#0 added to a predetermined pin of the PCI slot #0.

Similarly, when one of reset signals RS1 to RS4 from the control unit 70 and the reset signal 9 from the south bridge 6 becomes ON, the OR gates 21 to 24 turn ON reset signals RST#1 to RST#4 added to the PCI slots #1 to #4, respectively.

Here, the reset signals RS0 to RS4 from the control unit 70 are supplied in response to a command from the hypervisor (described later).

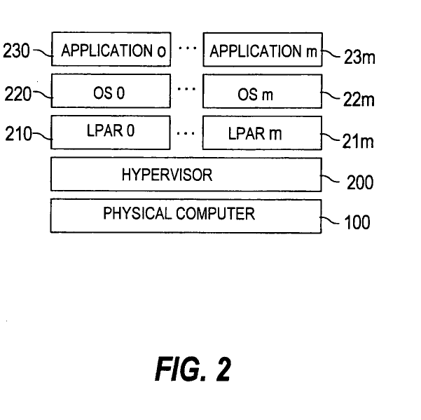

Now, referring to FIG. 2, software operated on the physical computer 100 will be described in detail.

A hypervisor 200 is operated on the physical computer 100. The hypervisor 200 divides the physical computer 100 into two or more logical partitions (LPAR's) LPAR0 (210) to LPARm (21m), and manages allocation of computer resources.

OS0 (220) to OSm (22m) are operated on the LPAR0 to LPARm, and an application 0 (230) to an application m (23m) are operated on the OS's.

The hypervisor allocates resources (computer resources) of the CPU's 1a and 1b, the memory 5, and the PCI slots #0 to #4 to the LPAR's (210 to 21m).

The number of CPU's may be one, or two or more. When the number of CPU's is two or more, the CPU's 1a and 1b are tightly coupled multiprocessors which share the memory 5.

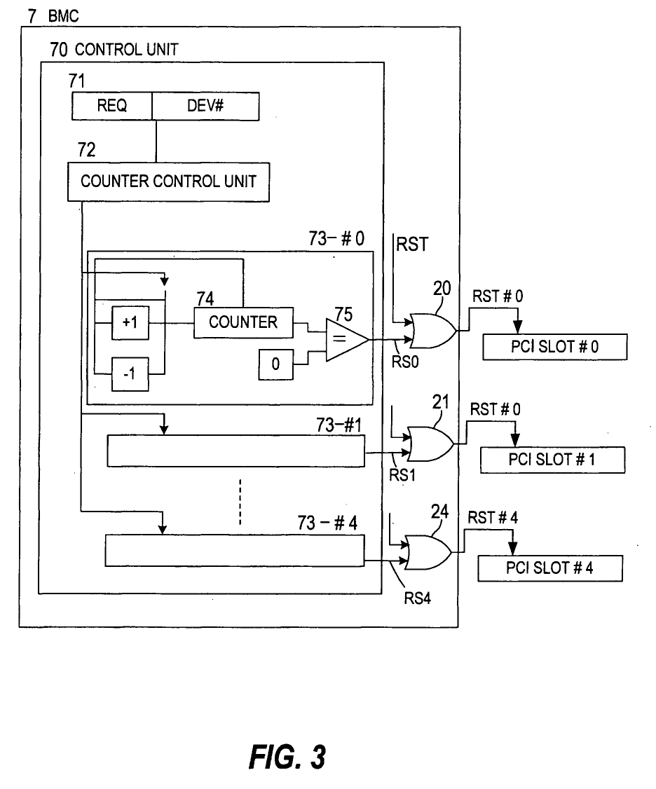

Next, referring to FIG. 3, the BMC 7 for initializing the PCI slots #0 to #4 in response to a command from the hypervisor 200 will be described in detail.

The control unit 70 of the BMC 7 includes a register 71 in/from which writing/reading can be executed from the hypervisor 200, a counter control unit 72 for executing writing in counters 74 of reset signal generation units 73-#0 to 73-#4 corresponding to the PCI slots #0 to #4, respectively, when writing is executed in the register 71, and OR gates 20 to 24 for outputting either reset signals RS0 to RS4 of the reset signal generation units 73-#0 to 73-#4, respectively, or the reset signal 9 from the south bridge 6.

First, the register 71 is constituted of areas (shown) of “REQ” for storing a request type (ACT or DEACT) and “DEV#” for storing a slot number (identifier) of a request target. The hypervisor 200 writes one of the PCI slot numbers #0 to #4 to be targeted in the area DEV# of the register 71 of the control unit 70. When one of the LPAR's 210 to 21m on the hypervisor 200 uses (allocates) a new PCI slot, a value of “+1” is written to indicate ACT. When the use of the PCI slot is finished (allocation is released), a value of “−1” is written to indicate DEACT. It should be noted that the ACT is used for starting a new LPAR, and the DEACT is used for finishing the OS on the LPAR.

When writing is executed in the register 71, the counter control unit 72 adds a value of the area REQ to the counter 74 of each of the reset signal generation units 73-#0 to 73-#4 corresponding to a PCI slot designated by the area DEV#.

Each of the reset signal generation units 73-#0 to 73-#4 is constructed in such a manner that an output of each counter 74 is connected to a comparator 75, and reset signals RS0 to RS4 are generated when a value of the counter 74 becomes 0. The reset signals RS0 to RS4 are supplied through the OR gates 20 to 24 to the PCI slots #0 to #4, respectively, as described above. Thus, independently of the reset signal 9 from the south bridge 6, it is possible to independently reset the PCI slots #0 to #4 in response to a command from the hypervisor 200.

At the time of booting the physical computer 100, all the PCI slots #0 to #4 are initialized by the reset signal 9 from the south bridge 6. The hypervisor 200 is booted to start the LPAR's 210 to 21m.

For example, when the LPAR 210 requests the hypervisor 200 to allocate the PCI slot #0, the hypervisor 200 writes “+1” indicating an ACT request and DEV#=#0 in the register 71. The counter control unit 72 adds the ACT value “+1” to the counter 74 of the reset signal generation unit 73-#0 corresponding to the DEV#. At this time, since a value of the counter 74 becomes +1, an output of a comparator 75 is not changed while the reset signal RS0 is kept OFF.

Next, when the LPAR 21m requests the hypervisor 200 to allocate the PCI slot #0, the hypervisor 200 writes “+1” indicating an ACT request and DEV#=#0 in the register 71. In the same manner as the above case, the counter control unit 72 adds the ACT value “+1” to the counter 74 of the reset signal generation unit 73-#0 corresponding to the DEV#. At this time, since a value of the counter 74 becomes +2, the output of the comparator 75 is not changed while the reset signal RS0 is kept OFF, and the PCI slot #0 is shared by the LPAR's 210 and 21m.

Next, when the LPAR 210 requests the hypervisor 200 to release allocation of the PCI slot #0, the hypervisor 200 writes “−1” indicating a DEACT request and DEV#=#0 in the register 71. In the same manner as the above case, the counter control unit 72 adds the DEACT value “−1” to the counter 74 of the reset signal generation unit 73-#0 corresponding to the DEV#. At this time, since a value of the counter 74 becomes +1, the output of the comparator 75 is not changed while the reset signal RS0 is maintained OFF.

Further, when the LPAR 21m requests the hypervisor 200 to release allocation of the PCI slot #0, the hypervisor 200 writes “−1” indicating a DEACT request and DEV#=#0 in the register 71. In the same manner as the above case, the counter control unit 72 adds the DEACT value “−1” to the counter 74 of the reset signal generation unit 73-#0 corresponding to the DEV#. As a result, since a value of the counter 74 becomes 0, the output of the comparator 75 is reversed to turn the reset signal RS0 ON. A reset signal RST#0 is input from the OR gate 20 to the PCI slot #0, and a PCI device (not shown) is initialized. The next time allocation occurs, the reset signal RS0 is returned to OFF because a value of the counter 74 becomes 1, whereby a device of the PCI slot #0 can be used from its initialized state.

When a single LPAR occupies a PCI slot, a PCI slot set to DEV# by setting a value of the counter 74 to +1 is allocated to the LPAR. Then, when the allocation of the LPAR is released, a value of the counter 74 becomes 0. Thus, reset signals RS0 to RS4 are generated by the comparator 75, a reset signal RST#n is input from the OR gate to the PCI slot, and the PCI device (not shown) is initialized.

As described above, the BMC 7 includes the register 71 in which writing can be executed from the hypervisor 200, and the reset signal generation units 73-#0 to 73-#4 corresponding to the device numbers DEV# of the register 71. When the values of the counters 74 of the reset signal generation units 73-#0 to 73-#4 become 0, reset signals RS0 to RS4 are generated, and supplied through the OR gates 20 to 24 to the PCI slots #0 to #4, respectively. Thus, it is possible to flexibly deal with dynamic resource changes on the virtual computer.

The BMC 7 is often mounted on a board in the case of a PC server or the like. Accordingly, the BMC 7 includes the register 71, the counter control unit 72, and the reset signal generation units 73-#0 to 73-#4 corresponding to the PCI slots, and the OR gates 20 to 24 are provided to the on-board PCI slots. Then, it is only necessary to add the reset signal 9 from the south bridge 6 and the outputs of the reset signal generation units 73-#0 to 73-#4. As a result, a PCI bus bridge or a complex additional control circuit is not necessary unlike the conventional example, and it is possible to easily construct a physical computer corresponding to a virtual computer which dynamically changes resources in the PC server or the like while suppressing an increase in manufacturing costs.

According to this invention, the I/O bus that executes logical division can be optionally initialized on a slot basis in accordance with the command from the hypervisor 200. Thus, it is not necessary to limit types of OS or devices of the PCI slots #0 to #4 operated on the hypervisor 200. This invention can be adapted to broad hardware configurations, and it is especially possible to realize a virtual computer on a personal computer (PC) in addition to the PC server.

Furthermore, when a plurality of guest OS's are operated on a host OS as in the case of VMWARE (registered trademark) operated similarly to the logical division, I/O devices used by the guest OS's are all managed by the host OS, and thus it is not necessary to execute initialization when the guest OS's are turned ON/OFF. With this configuration, however, since the guest OS is operated as an application of the host OS, an overhead becomes extremely large. On the other hand, according to this invention, the hypervisor 200 as the firmware operates each OS on the logically divided LPAR, and an allocation request of the I/O devices (PCI slots #0 to #4) or the like is made from each OS through the hypervisor 200. Thus, without generating the aforementioned overhead, performance of the physical computer can be sufficiently used.

### FIRST MODIFIED EXAMPLE

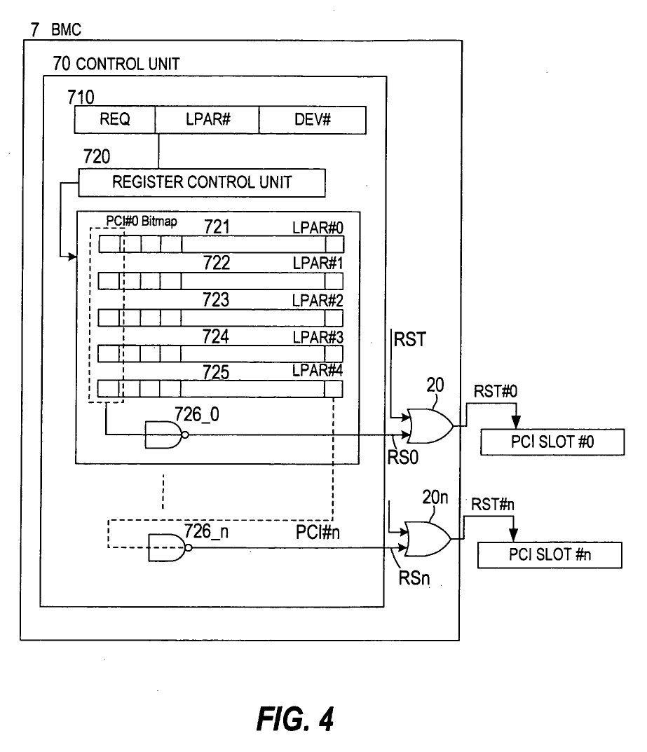

FIG. 4 shows a first modified example in which the counter 74 of the control unit 70 of the firs embodiment is disposed for each of resisters 721 to 725 of LPAR's, and NAND gates 726-0 to 726-n are disposed for generating reset signals RS0 to RS4 based on a bit map of the resisters 721 to 725. Other components are similar to those of the first embodiment. It should be noted that registers corresponding to LPAR's are set by a number equal to that of LPAR's 210 to 21m (not shown).

First, a register 710 is constituted of areas (shown) of “REQ” for storing a request type (ACT or DEACT), “LPAR#” for storing an identifier of an LPAR of a request source, and “DEV#” for storing a slot number of a request target.

A hypervisor 200 writes one of target PCI slot numbers #0 to #4 in the area DEV# of the register 710 of the control unit 70, and simultaneously values of request source LPAR0 to LPARm in the LPAR#. Then, when the request source LPAR's request allocation, bits of the registers 721 to 725 corresponding to the PCI slots #0 to #4, respectively, are set to ON (=1). Alternatively, when the request source LPAR's request allocation releasing, the bits of the registers 721 to 725 corresponding to the PCI slots #0 to #4, respectively, are set to OFF (=0). Here, a most significant bit of the registers 721 to 725 corresponds to the PCI slot #0, a least significant bit corresponds to a PCI slot #n, and n=4 is assumed.

The NAND gates 726_0 to 726_{—}n are connected to the identical bits of the registers 721 to 725, respectively. When all the bits become 0, reset signals RS0 to RS4 are generated, and the reset signals RST0 to RST4 are supplied through the OR gates 20 to 24 to the PCI slots #0 to #4, respectively.

This case is similar to the first embodiment. For example, while the LPAR 210 singly uses the PCI slot #0, a most significant bit of the register 721 is 1. When the LPAR 210 finishes the use, the most significant bit of the register 721 becomes 0, a reset signal RST0 is generated, and the PCI slot #0 is reset.

While the LPAR 210 and the LPAR 21m use the PCI slot #0, the most significant bits of the registers 721 and 722 are both 1. When the LPAR's 210 and 21m finish the uses, the most significant bits of the registers 721 and 722 become 0, a reset signal RST0 is generated, and the PCI slot #0 is reset.

Thus, at the time of finishing the single or shared use, the PCI slots #0 to #4 can be initialized, resisters or the like of PCI devices (not shown) connected to the PCI slots #0 to #4 can be cleared, and next allocation can be smoothly carried out.

### SECOND MODIFIED EXAMPLE

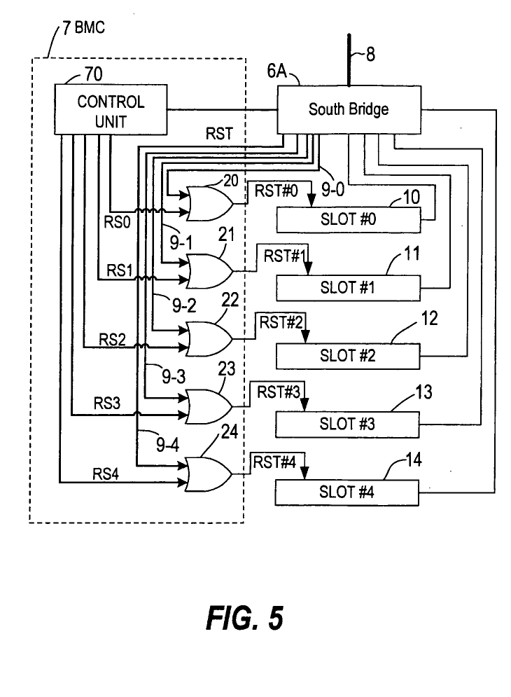

FIG. 5 shows a second modified example in which the PCI bus (shared bus) of the first embodiment is applied to a point-to-point I/O bus (e.g., PCI Express). Referring to FIG. 5, the second modified example is different from the first embodiment in that a south bridge 6A is connected point to point from slots #0 to #4, and reset signals 9-0, 9-1, 9-2, 9-3, and 9-4 are independent for every slot. A virtual computer is not supposed for the south bridge used in a server or a personal computer. Accordingly, at the time of booting a system, the reset signals 9-0 to 9-4 corresponding to all the slots are simultaneously turned ON. Other components are similar to those of the first embodiment. The reset signals 9 for initializing all the I/O buses are input to the OR gates 20 to 24 disposed for the slots #0 to #4, and the reset signals RS0 to RS4 from a control unit 70 are also input to the OR gates 20 to 24.

The control unit 70 includes a counter 74 similar to that of the first embodiment, or registers 721 to 725 similar to those of the first modified example, and reset signals RS0 to RS4 are generated for every slot in response to a command from the hypervisor 200.

### THIRD MODIFIED EXAMPLE

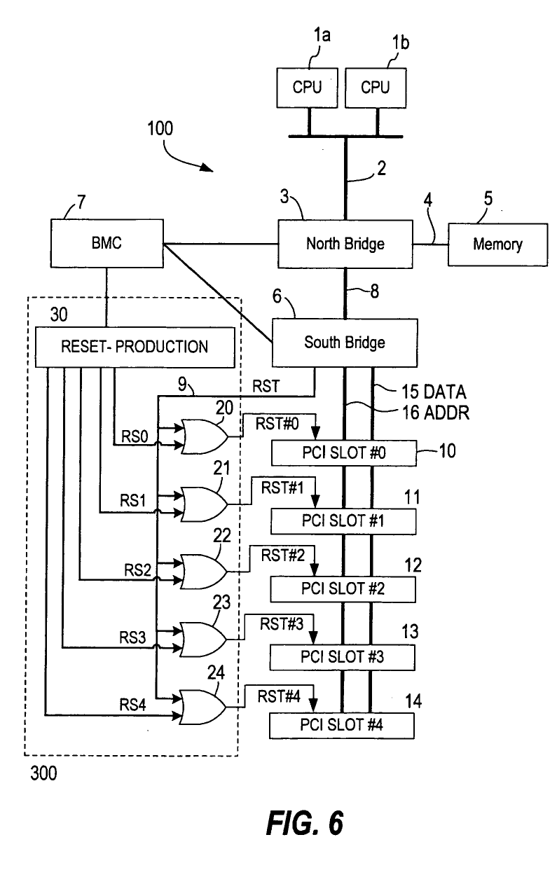

FIG. 6 shows a third modified example in which the register 71, the counter control unit 72 and the reset signal generation units 73-#0 to 73-#4 of the first embodiment are provided independently of the BMC 7 to constitute a reset signal generation control unit 30. Other components are similar to those of the first embodiment.

In this case, the existing BMC 7 is directly used as an interface to the hypervisor 200, and the reset signal generation control unit 30 and the OR gates 20 to 24 only need to be added on the board of the physical computer 100. Thus, a change of the BMC 7 can be limited to a minimum.

In this case, in place of the counter control unit 72 and the counter 74, the computer can include the register 710, a register control unit 720, and the registers 721 to 725 as in the case of the first modified example.

The embodiment has been described by way of example in which the control unit 70 for individually generating the reset signals in the PCI slots #0 to #4 is disposed in the BMC 7. However, the control unit may be disposed in the north bridge 3 or the south bridge 6.

According to the embodiment, the front side bus 2 is used as the shared bus. However, it may be a point-to-point crossover type bus. Similarly, the north bridge 3 and the south bridge 4 may be interconnected through a crossover type bus. Moreover, the memory bus 4 is connected to the north bridge 3. However, the memory bus may be connected to the CPU's 1a and 1b.

Furthermore, the embodiment has been described by taking the example of the physical computer 100 equipped with one PCI bus. However, although not shown, this invention can be applied to a physical computer equipped with a plurality of I/O buses, and to a physical computer equipped with a plurality of different I/O buses. For example, in a physical computer equipped with a PCI Express bus in addition to a PCI bus and a PCI-X bus, reset signals may be generated individually for slots of I/O buses.

As described above, according to this invention, the reset signals can be individually supplied to the I/O buses. Thus, it is possible to provide a physical computer (server or personal computer) optimal for a virtual computer that dynamically changes resources.

While the present invention has been described in detail and pictorially in the accompanying drawings, the present invention is not limited to such detail but covers various obvious modifications and equivalent arrangements, which fall within the purview of the appended claims.

1. A computer, comprising:
firmware that divides a physical computer into a plurality of logical partitions, operates an OS on each logical partition, and allocates resources of the physical computer to the logical partitions;
an I/O bus comprising a plurality of slots;
an I/O control unit that controls the I/O bus; and
a slot initialization unit that individually sends a first reset signal to each of the slots,
the I/O control unit comprising a bus initialization unit that sends a second reset signal to the entire I/O bus,
the bus initialization unit sending the second reset signal at least at a time of booting the computer,
the slots each being initialized based on one of the first reset signal and the second reset signal.

2. The computer according to claim 1, wherein the slot initialization unit decides a slot to be allocated to the logical partition based on a request from the firmware, and sends the first reset signal to the slot allocated to the logical partition at a time of one of finishing and starting use of an OS on the logical partition.

3. The computer according to claim 2, wherein:
the slot initialization unit comprises:
a request storage unit that stores an identifier of a slot requested from the firmware and a type of allocation request to the slot;
a counter that is set corresponding to the identifier of each of the slots; and
a counter control unit that adds a predetermined value to the counter when the type of request is an allocation request, and subtracts a predetermined value from the counter when the type of request is an allocation releasing request; and
when a value of the counter becomes 0, the first reset signal is sent to the slot of the identifier corresponding to the counter.

4. The computer according to claim 2, wherein:
the slot initialization unit comprises:
a request storage unit that stores an identifier of a slot requested through the firmware, a type of allocation request to the slot, and an identifier of a logical partition which has requested the firmware;
a register that is set corresponding to the identifier of each of the logical partitions and has a corresponding bit preset for each identifier of the slot; and
a register control unit that sets the bit corresponding to the identifier of the slot to ON for the register corresponding to the identifier of the logical partition when the type of request is an allocation request, and to OFF for the register corresponding to the identifier of the logical partition when the type of request is an allocation releasing request; and
when bits of all the registers of the identifiers of the slots become OFF, the first reset signal is sent to each of the slots.

5. The computer according to claim 1, wherein the slot initialization unit decides a slot to be allocated to the logical partition based on a request from the firmware, causes the plurality of logical partitions to share the slot when the slot is allocated to the other logical partitions, and sends the first reset signal to the slot at a time of finishing use of an OS on all the logical partitions allocated to the slots.

6. The computer according to claim 5, wherein:
the slot initialization unit comprises:
a request storage unit that stores an identifier of a slot requested from the firmware and a type of allocation request to the slot;
a counter that is set corresponding to the identifier of each of the slots; and
a counter control unit that adds a predetermined value to the counter when the type of request is an allocation request, and subtracts a predetermined value from the counter when the type of request is an allocation releasing request; and
when a value of the counter becomes 0, the first reset signal is sent to the slot of the identifier corresponding to the counter.

7. The computer according to claim 5, wherein:
the slot initialization unit comprises:
a request storage unit that stores an identifier of a slot requested through the firmware, a type of allocation request to the slot, and an identifier of a logical partition which has requested the firmware;
a register that is set corresponding to the identifier of each of the logical partitions and has a corresponding bit preset for each identifier of the slot; and
a register control unit that sets the bit corresponding to the identifier of the slot to ON for the register corresponding to the identifier of the logical partition when the type of request is an allocation request, and to OFF for the register corresponding to the identifier of the logical partition when the type of request is an allocation releasing request; and
when bits of all the registers of the identifiers of the slots become OFF, the first reset signal is sent to each of the slots.

8. The computer according to claim 1, wherein the slot initialization unit decides a slot to be allocated to the logical partition based on a request from the firmware, causes the plurality of logical partitions to share the slot when the slot is allocated to the other logical partitions, and sends the first reset signal to the slot when the slot is first used in a logical space to which the slot has been allocated.

9. The computer according to claim 8, wherein:
the slot initialization unit comprises:
a request storage unit that stores an identifier of a slot requested from the firmware and a type of allocation request to the slot;
a counter that is set corresponding to the identifier of each of the slots; and
a counter control unit that adds a predetermined value to the counter when the type of request is an allocation request, and subtracts a predetermined value from the counter when the type of request is an allocation releasing request; and
when a value of the counter becomes 0, the first reset signal is sent to the slot of the identifier corresponding to the counter.

10. The computer according to claim 8, wherein:
the slot initialization unit comprises:
a request storage unit that stores an identifier of a slot requested through the firmware, a type of allocation request to the slot, and an identifier of a logical partition which has requested the firmware;
a register that is set corresponding to the identifier of each of the logical partitions and has a corresponding bit preset for each identifier of the slot; and
a register control unit that sets the bit corresponding to the identifier of the slot to ON for the register corresponding to the identifier of the logical partition when the type of request is an allocation request, and to OFF for the register corresponding to the identifier of the logical partition when the type of request is an allocation releasing request; and
when bits of all the registers of the identifiers of the slots become OFF, the first reset signal is sent to each of the slots.

11. The computer according to claim 1, further comprising a monitoring unit that monitors hardware including the I/O control unit, wherein the slot initialization unit is mounted on the monitoring unit.

12. The computer according to claim 1, wherein the slot initialization unit is mounted on the I/O control unit.

13. The computer according to claim 1, wherein the computer comprises a personal computer.
